(19) United States
(12) Patent Application Publication
(10) Pub. No.: US 2025/0182774 A1
(43) Pub. Date: Jun. 5, 2025

(54) MULTICHANNEL AND MULTI-STREAM SOURCE SEPARATION VIA MULTI-PAIR PROCESSING

(71) Applicant: Dolby Laboratories Licensing Corporation, San Francisco, CA (US)

(72) Inventors: Aaron Steven MASTER, San Francisco, CA (US); Lie LU, Dublin, CA (US); Scott Gregory NORCROSS, San Rafael, CA (US)

(73) Assignee: Dolby Laboratories Licensing Corporation, San Francisco, CA (US)

(21) Appl. No.: 18/851,983

(22) PCT Filed: Mar. 17, 2023
(86) PCT No.: PCT/US2023/015484

§ 371 Date: Sep. 27, 2024

Related U.S. Application Data
(60) Provisional application No. 63/482,958, filed on Feb. 2, 2023.
(60) Provisional application No. 63/325,118, filed on Mar. 29, 2022.

(51) Int. Cl. G10L 21/0272; G10L 21/0224; G10L 21/0232; H04S 7/00

(52) U.S. Cl. CPC G10L 21/0272; G10L 21/0224; G10L 21/0232; H04S 7/30

(57) ABSTRACT

A method and system for separating a target audio source from a multi-channel audio input including N audio signals, N>=3. The N audio signals are combined into at least two unique signal pairs, and pairwise source separation is performed on each signal pair to generate at least two processed signal pairs, each processed signal pair including source separated versions of the audio signals in the signal pair. The at least two processed signal pairs are combined to form the target audio source having N target audio signals corresponding to the N audio signals.

### CROSS REFERENCE TO RELATED APPLICATIONS

This application claims priority to U.S. provisional application No. 63/325,118 filed 29 Mar. 2022 and U.S. provisional application 63/482,958, filed 2 Feb. 2023, all of which are incorporated herein by reference in their entirety.

### TECHNICAL FIELD OF THE INVENTION

The present invention relates to source separation of multi-channel audio signals, such as left-right-center audio signals.

### BACKGROUND OF THE INVENTION

Source separation in audio processing relates to systems and methods for isolating a target audio source (e.g. dialog or music) present in an original audio signal comprising a mix of the target audio source and additional audio content. The additional audio content is for example stationary or non-stationary noise, background audio or reverberation effects.

Source separation is particularly challenging for multi-channel input, i.e. inputs with three or more channels, where the source of interest potentially is present in all these channels. One example is left, right, center (L, R, C) audio, where dialogue may be present primarily in the center channel, but to a varying degree also in the left and right channels.

Approaches for source separation of stereo input are not necessarily appropriate for multi-channel input. Thus, there is a need for a source separation approach which can handle multi-channel inputs in a satisfactory manner.

### GENERAL DISCLOSURE OF THE INVENTION

It is an objective of the present invention to provide source separation for multi-channel input (three or more channels).

According to a first aspect of the invention, this objective is achieved by a method for separating a target audio source from a multi-channel audio input including N audio signals, N>=3, the method comprising combining the N audio signals into at least two unique signal pairs, each signal pair including two of the N audio signals, performing pairwise source separation on the at least two signal pairs to generate at least two processed signal pairs, each processed signal pair including source separated versions of the audio signals in the signal pair, and combining the at least two processed signal pairs to form the target audio source having N target audio signals corresponding to the N audio signals.

According to a second aspect of the invention, this objective is achieved by a system for separating a target audio source from a multi-channel audio input including a set of N audio signals, N>=3, the system comprising a pair forming module configured to combine the N audio signals into at least two unique signal pairs, each signal pair including two of the N audio signals, a processing module configured to perform pairwise source separation on the at least two signal pairs to generate at least two processed signal pairs, each processed signal pair including source separated versions of the audio signals in the signal pair, and a combination module configured to combine the at least two processed signal pairs to form the target audio source having N target audio signals corresponding to the N audio signals.

By “multi-channel” input is here intended any audio input with multiple signals, not only such signals conventionally referred to as “channels”. For example, the signals of the multi-channel input may include surround audio channels, multi-track signals, higher order ambisonic signals, object audio signals and/or immersive audio signals.

By “pairwise source separation” is intended processing performed on a pair of signals with the purpose of separating a single (target) audio source. Information from both signals is used in the processing, and correlation between the signals may improve the source separation process.

In many types of content, such as music or effects, typical mixing practice may lead to a target source being present in two channels. This could occur for channel-based content (e.g. 5.1 or 7.1), or immersive content which has been authored as channel-based or rendered to channels (e.g. 5.1.2 or 7.1.4). In such cases, pairwise processing according to the first aspect of the invention will be able to efficiently and accurately model the mixing and extract a target source.

The choice of unique signal pairs is not necessarily random or exhaustive and may be targeted to specific expected content and target sources. Consider an example of 5.1 channel format content, typical in cinema and broadcast, where the target source is dialog. In such content, dialog is typically present in the center channel at a higher level than in other channels. Dialog is almost always present exclusively in the three screen channels: Left (L), Center (C), and Right (R). It is rarely and almost never “phantom center” panned, i.e. only present in the L and R channels without being present in the C channel. These realities suggest that the pairs of interest for this case be LC and CR. This allows the pairwise processing to exploit cues that result from the mixing.

Some audio signals may occur only in a single unique signal pair, and for such audio signals the corresponding target audio signal may be equal to the (single) source separated version of this audio signal. Other audio signals may occur in more than one unique signal pair, and for such audio signals the corresponding target audio signal may be equal to a weighted combination of all (different) source separated versions of this audio signal.

The weighting of source separated versions may be dynamic in time and/or frequency. It may be linear or non-linear.

The N target audio signals may be mixed with the N audio signals to form N output audio signals. Such mixing allows reintroducing content which is not present in the target audio signals. If the multi-channel input includes M>N audio signals, i.e. some audio signals that are not included in the pair-wise processing and do not have a corresponding target signal, the N target audio signals may be mixed with these M audio signals to form M output audio signals. The mixing may be done with a mixing ratio that is dynamic in time and/or frequency.

The pairwise source separation may include processing the audio signals in the signal pair with a spatial separation module to obtain an intermediate audio signal and processing the intermediate audio signal with a source separation module to generate an output audio signal, wherein the source separation module implements a neural network trained to predict a noise reduced output audio signal given samples of the intermediate audio signal. Such processing is discussed in more detail in U.S. Provisional Application No. 63/482,949 titled “SOURCE SEPARATION BASED ON SPATIAL CUES AND SOURCE CUES” (Docket No. D22011USP3), hereby incorporated by reference.

The invention according to the second aspect features the same or equivalent benefits as the invention according to the first aspect. Any functions described in relation to a method may have corresponding features in a system or device, and vice versa.

### BRIEF DESCRIPTION OF THE DRAWINGS

The present invention will be described in more detail with reference to the appended drawings, showing currently preferred embodiments of the invention.

FIG. 1 shows a schematic block diagram of a system according to a first embodiment of the invention.

FIG. 2 shows the combination module in FIG. 1 in more detail.

FIG. 3 shows an additional module which optionally may be added to the process in FIG. 1.

FIG. 4 shows a schematic block diagram of a system according to a second embodiment of the invention.

FIG. 5 shows a mapping between the weighting coefficients in FIG. 4 and a ratio between penalty adjusted energies.

FIG. 6 is a flow-chart of a process according to an embodiment of the present invention.

### DETAILED DESCRIPTION OF CURRENTLY PREFERRED EMBODIMENTS

Systems and methods disclosed in the present application may be implemented as software, firmware, hardware, or a combination thereof. In a hardware implementation, the division of tasks does not necessarily correspond to the division into physical units; to the contrary, one physical component may have multiple functionalities, and one task may be carried out by several physical components in cooperation.

The computer hardware may for example be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions (sequential or otherwise) that specify actions to be taken by that computer hardware. Further, the present disclosure shall relate to any collection of computer hardware that individually or jointly execute instructions to perform any one or more of the concepts discussed herein.

Certain or all components may be implemented by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system (i.e. a computer hardware) that includes one or more processors. Each processor may include one or more of a CPU, a graphics processing unit, and a programmable DSP unit. The processing system further may include a memory subsystem including a hard drive, SSD, RAM and/or ROM. A bus subsystem may be included for communicating between the components. The software may reside in the memory subsystem and/or within the processor during execution thereof by the computer system.

The one or more processors may operate as a standalone device or may be connected, e.g., networked to other processor(s). Such a network may be built on various different network protocols, and may be the Internet, a Wide Area Network (WAN), a Local Area Network (LAN), or any combination thereof.

The software may be distributed on computer readable media, which may comprise computer storage media (or non-transitory media) and communication media (or transitory media). As is well known to a person skilled in the art, the term computer storage media includes both volatile and non-volatile, removable and non-removable media implemented in any method or technology for storage of information such as computer readable instructions, data structures, program modules or other data. Computer storage media includes, but is not limited to, physical (non-transitory) storage media in various forms, such as EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information, and which can be accessed by a computer. Further, it is well known to the skilled person that communication media (transitory) typically embodies computer readable instructions, data structures, program modules or other data in a modulated data signal such as a carrier wave or other transport mechanism and includes any information delivery media.

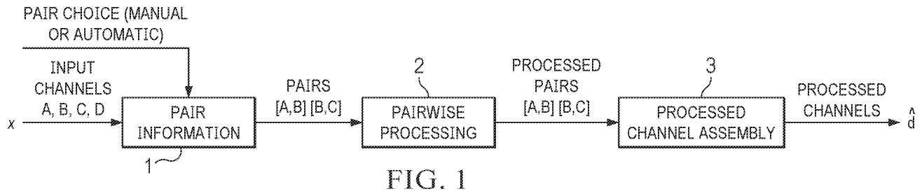

FIG. 1 shows, on a high level, a system for separation of a target audio source \hat{d} from a generic multi-channel audio input x with N signals. In the illustrated example, N=4, and the signals are labeled “A”, “B”, “C”, and “D”. The system in FIG. 1 applies pair-wise source separation according to one implementation of the present invention. Pair-wise source separation means processing a pair of signals with the purpose of separating a single (target) audio source. Information from both signals in the pair maybe used to separate the target audio source, thereby improving the source separation.

In order to allow pair-wise processing, the signals of the multichannel audio input x (i.e. in this case A, B, C and D) need to be combined into at least two unique signal pairs. For this purpose, the signals A, B, C, D are received by a pair forming module 1, and unique signal pairs are formed as specified by a user or governed by an automated process. The formation of signal pairs can be governed by assumptions about which signals of the multichannel input are likely to contain the target audio source. As an example, dialog is normally only present in the left, right and center signals of a surround input format such as 5.1. However, for some sources, it may be difficult to make assumptions, and an automated process may be implemented to make appropriate signal pair combinations. Such an automated process may, inter alia, involve source identification in each signal.

In the example shown, two unique signal pairs are formed: [A,B] and [B,C]. It is noted that one of the four signals, B, is included in both signal pairs, while one of the four signals, D, is not included in any of the signal pairs. This indicates that the target audio source is assumed to be present in signals A, B and C, and not to be present in signal D. When forming two unique signal pairs of the three signals A, B, C, one signal will occur in both pairs. In the present example, signal B occurs in both pairs, possibly implying that the target audio source is expected to be primarily present in this signal.

The unique signal pairs are received by a processing module 2, where each signal pair is subject to pairwise source separation. In the example shown this means that [A,B] is pairwise processed and [B,C] is pairwise processed by an appropriate source separation algorithm. Various source separation algorithms, suitable for processing signal pairs, are available in the art. Such source separation algorithms serve to process the signal pair in order to provide a processed signal pair including (almost) only the target audio source. The output is referred to as processed signal pairs, with each processed signal pair including source separated versions of the audio signals in the corresponding unique signal pair. So, in the simple example of a stereo signal, pairwise source separation will process both left and right signals in one process in order to provide a processed stereo signal including only (to the extent possible) the target audio source, e.g. dialog or a particular musical instrument.

If a particular audio signal occurs in more than one unique signal pair, there will be more than one source separated versions of this audio signal. In the illustrated example, this is the case for signal B, which occurs in two unique signal pairs. For this reason, the various source separated versions of the audio signals need to be combined in order to form the target audio source d. In combination module 3, the target audio source d is assembled from the processed signal pairs according to a given set of conditions. As an example, the following conditions can be applied:
a) For each audio signal represented in only one signal pair, set the corresponding target audio signal equal to the processed version of this audio signal. In the example, target signals A and C would be equal to the processed versions of audio signals A and C present in the processed signal pair [A,B] and [B,C].
b) For each audio signal represented in two or more signal pairs, set the corresponding target signal equal to a weighted combination of the two or more processed versions of this audio signal. In the example shown, signal B is present in two pairs, [A,B] and [B,C], and the corresponding target signal \hat{d}_{B} is obtained by a combination, e.g. a linear combination, of 1) the processed version of audio signal B from the processed signal pair [A,B] and 2) the processed version of audio signal B from the processed signal pair [B,C].
c) For each audio signal not represented in any pair, output zero for that channel. In the example shown, channel D is not represented in any pair, so the corresponding target audio signal is set to zero.

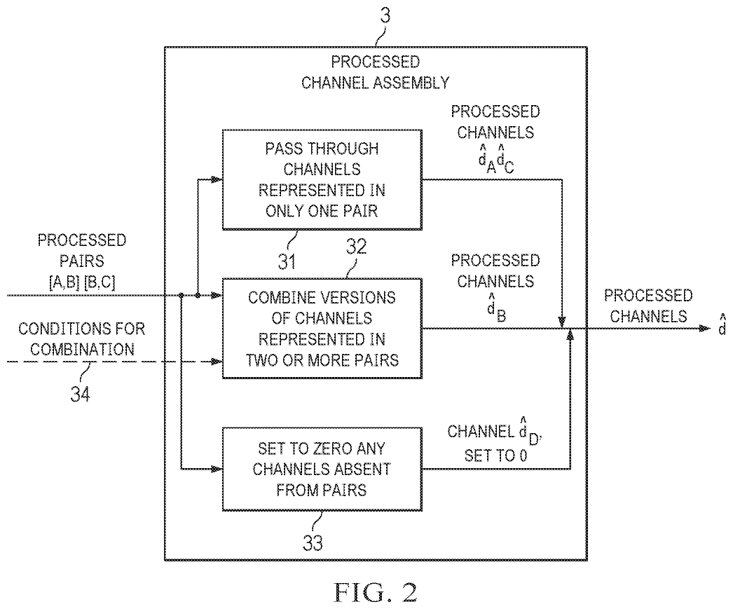

FIG. 2 depicts combination module 3 in more detail, for the example shown in FIG. 1. Combination module 3 here has three sub-blocks 31, 32, 33, relating to the three situations a), b), c) outlined above. The weighting applied in sub-block 32 may be equal across contributing pairs or may be governed by conditions 34 favoring some pair or pairs over another pair or pairs. Further the weighting may be dynamic vs time, frequency or both. The conditions 34 may be based on the input, processed input, or other factors. As an example, the weight assigned to a channel pair may be proportional to its energy or loudness; this way, the pair or pairs with greater energy or loudness will have a greater influence on the output. Also other conditions governing the linear (or non-linear) combination may be used.

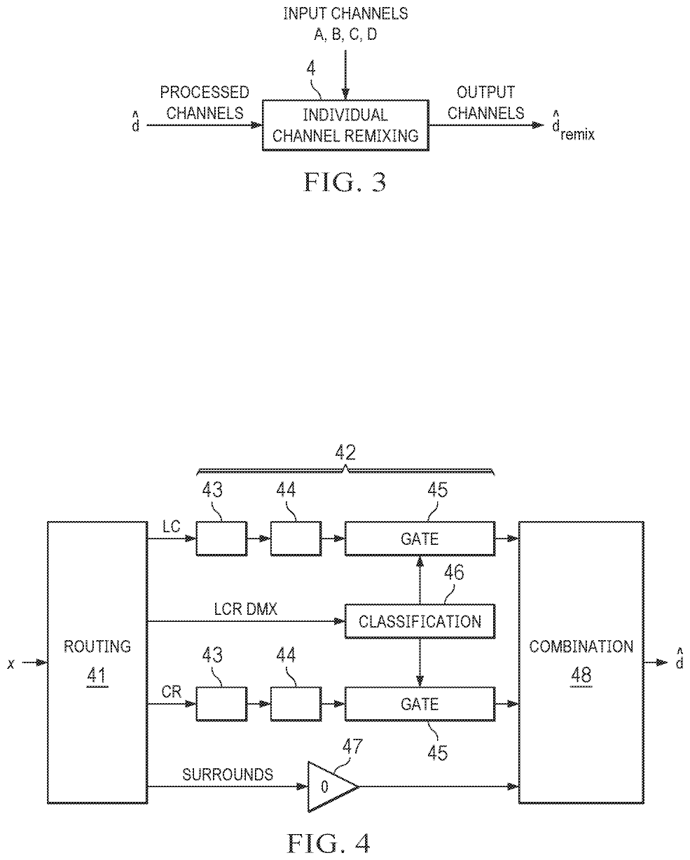

FIG. 3 depicts an optional mixing module 4 for all channels, configured to mix each target source signal \hat{d}ᵢ (i=A, B, C, D) with the corresponding input signal A, B, C, D, in some ratio. For each channel, channel input signals A, B, C, D multiplied by a scale factor is added to the processed channel signal \hat{d}ᵢ (i=A, B, C, D) (as shown to the right in FIG. 1) multiplied by a scale factor, and output the resulting sum, \hat{d}ᵣₑₘᵢₓ. The scale factors may differ for each channel and may vary by time, frequency, or both. Such mixing allows reintroducing content which is not present in the target source signals, i.e. which has been excluded during the source separation process. There may be various reasons to reintroduce (parts of) such content. In some situations, a too isolated target source is not attractive, and benefits from slight “disturbances” from surrounding noise. Also, there may be contextual reasons, e.g. dialogue which is difficult to comprehend without the appropriate cue from surrounding noise. The reintroduced content may relate to a particular signal (signal D in the present example) which was not represented in any of the processed pairs so that this channel would otherwise have an output of zero. The reintroduces content could alternatively be from signals that were included in the processing (signals A, B, C in the present example) but which has been completely excluded in the source separation process.

The general approach described above will in the following be exemplified in the specific case of separating dialog from the left, right and center (L, R, C) channels of a surround signal, e.g. a 5.1 or 7.1 mix. FIG. 4 shows a system for pairwise processing of an audio input in the form of a surround signal x.

The surround signal x is routed in a routing module 41, substantially corresponding to pair forming module 1 in FIG. 1. As dialog can be assumed to be present only in the L, R, C channels, only these channels are included in the unique signal pairs, and the routing module 41 provides two unique signal pairs, [L, C] and [C, R]. The unique signal pairs are each processed in identical processing paths 42, here including a spatial cue based separation module 43, a source cue based separation module 44, and a gating module 45.

In brief, spatial cue based separation module 43 is configured to process the audio signals in a signal pair to obtain an intermediate audio signal pair, while the source cue based separation module 44 is configured to process the intermediate audio signal pair to generate a processed signal pair.

More specifically, the spatial cue based separation module 43 is configured to extract a mixing parameter of the signal pair and modify the two audio signals based on the mixing parameter to obtain the intermediate audio signal pair. The mixing parameter indicates a property of the mixing of the at least two audio signals. One or more mixing parameters may be determined for each time segment and frequency band of the audio signals. In some implementations the mixing parameter indicates at least one of a distribution of the panning of the two signals and a distribution of the inter-channel phase difference of the at least two audio signals in a time segment and frequency band. The processing performed by the spatial cue based separation module 43 may entail adjusting the at least two audio signals, based on the detected mixing parameter, to approach a predetermined mixing type. The predetermined mixing type is selected based on the capabilities of the subsequent source cue based separation module 44. For example, the predetermined mixing type may be an approximately center-panned mixing and/or a mixing with little to no inter-channel phase difference.

The spatial cue based separation module 43 can operate in a transform domain, such as in Short-Time Fourier Transform (STFT) domain or quadrature mirror filterbank (QMF) domain, or in a time domain, such as in the waveform domain. Each audio signal in the signal pair is divided into a plurality of fine granularity time-frequency tiles (e.g. STFT tiles) wherein each tile represents a limited time duration of the audio signal in a predetermined frequency band.

The spatial cue based separation module 43 outputs a resulting intermediate audio signal pair which comprises audio content of a spatial mix which is easier for the source cue based separation module 44 to process (e.g. a center panned audio signal with little to no inter-channel phase difference).

The source cue based separation module 44 here comprises a neural network trained to predict a noise reduced output audio signal given samples of the intermediate audio signal. The neural network has been trained to identify target audio content, in the illustrated example dialog, and amplify this content. Alternatively, the neural network has been trained to identify undesired audio content (e.g. stationary or non-stationary noise) and attenuate the undesired audio content. To achieve this, the neural network may comprise a plurality of neural network layers and may e.g., be a recurrent neural network. By providing the spatial cue based separation module 43 immediately upstream the source cue based separation module 44, the performance of the module 44 can be satisfactory even if the neural network is trained using mono signals.

Optionally, the source cue based separation module 44 is provided with metadata indicating at least one of a time resolution and a frequency resolution at which the spatial cue based separation module 43 operates. Such metadata may be obtained from an external source (e.g. user specified or accessed from a database) or the time and/or frequency metadata may be provided by the spatial cue based separation module 43. The source cue based separation module 44 may then process the intermediate audio signal pair based on the metadata.

In some implementations, the spatial cue based separation module 43 operates with a time and/or frequency resolution which is much lower (i.e. coarser) compared to the resolution of the source cue based separation module 44. For instance, the spatial cue based separation module 43 may operate with quasi-octave frequency bands with a bandwidth of at least 400 Hz and mixing parameters updated with a stride of about 140 ms. However, the source cue based separation module 44 may operate on individual STFT segments with a time resolution of a few milliseconds (e.g. 20 ms) and a frequency resolution of about 10 Hz.

In the illustrated example, the processing path 42 further comprises a gating unit 45 configured to apply a gain to the processed signal pair based on a probability metric indicating a likelihood that the multi-channel audio input comprises dialog. The likelihood is obtained using a neural network based classifier 46. For example, the classifier 46 may include a residual network (ResNet) with spectrogram input (including a number of frequency bands and frames). Alternatively, it may include a manual feature extraction with spectrogram input, and a simpler ResNet or multilayer perceptron (MLP) with manual feature as input to predict the likelihood metric.

In order to reduce processing power and memory, one single neural network classifier 46 may be used for both processing paths 42. The classifier 46 here operates on a downmix of the L, R, C channels, also provided by the routing module 41.

The classifier 46 obtains the LRC downmix and determines a probability metric indicating a likelihood that the input audio signal comprises dialog. The probability metric may be a value, wherein lower values indicate a lower likelihood and higher values indicates a higher likelihood. In some implementations, the classifier 46 comprises a neural network trained to predict the probability metric indicating the likelihood that the input audio signal comprises dialog content given samples of the LRC downmix.

The probability metric is provided to the gating units 45 which control a gain of the processed signal pairs based on the likelihood. For example, if the probability metric determined by the classifier 46 exceeds a predetermined threshold the gating units 45 apply a high gain and otherwise the gating unit applies a low gain. In some implementations, the high gain is unity gain (0 dB) and the low gain is essentially a silencing of the audio signal (e.g. −25 dB, −100 dB, or −∞ dB). In this way, the output audio signal becomes gated by the gating unit 60 to isolate the target audio content. For example, the gated output audio signal comprises only speech and is essentially silenced for time instances when there is no speech.

In some implementations, the gating units 45 are configured to smooth the gain applied by implementing a finite transition time from the low gain to the high gain and vice versa. With a finite transition time, the switching of the gating unit may become less noticeable and disruptive. For example, the transition from the low gain (e.g. −25 dB) to the high gain (e.g. 0 dB) may take about 180 ms and the transition from the high gain to the low gain may take about 800 ms, wherein the output signal when there is no target audio content is further suppressed by a complete silencing (−100 dB or −∞ dB) of the output audio signal after the high to low transition has elapsed.

In this way, when dialog is present in the audio input, the processing path 42 will emphasize the dialog by separating the dialog using spatial cues and source cues making the dialog more clear and intelligible. When dialog is not present, the audio input will be attenuated (silenced).

The modules 43-46 are described in more detail in co-pending patent application SOURCE SEPARATION BASED ON SPATIAL CUES AND SOURCE CUES, (Docket No. D22011) hereby incorporated by reference.

The routing module 41 also separates any surround signals, e.g. Ls and Rs of a 5.1-mix, or Ls, Rs, Lrs, Rrs of a 7.1-mix, and provides them to an attenuator 47. In the illustrated case, the surround signals are set to zero, and will not have any impact on the final output.

A combination module 48 receives the processed signal pairs from the gating modules 45, and combines them according to specified weighting conditions to provide the separated dialog d. In this case, the left and right channels will only be present in one of the processed signal pairs, while the center channel will be present in both processed signal pairs. The (single) source separated version of the left and right signals can be denoted L_{proc} and R_{proc}, while the (two different) source separated versions of the center channel can be referred to as C1_{proc} and C2_{proc}.

The separated dialog can then be expressed as a linear combination of the source separated versions, according to:

$$\hat{d} = [ \begin{matrix}{\hat{d}}_{L} \\ {\hat{d}}_{C} \\ {\hat{d}}_{R}\end{matrix} ] = [ \begin{matrix}{c}_{LCL} & 0 & 0 & 0 \\ 0 & {c}_{LCC} & {c}_{CRC} & 0 \\ 0 & 0 & 0 & {c}_{CRR}\end{matrix} ] [ \begin{matrix}{L}_{proc} \\ C {1}_{proc} \\ C {2}_{proc} \\ {R}_{proc}\end{matrix} ] , \qquad ( eq . 1 )$$

where c_{LCL}, c_{LCC}, c_{CRC} and c_{CRR} are weighting coefficients.

In a straight-forward example, the source separated versions of the left and right channels are used as left and right dialog channel, while the center dialog channel is an average of the two different source separated versions. This corresponds to setting the coefficients in eq. 1 to c_{LCL}=1, c_{LCC}=0.5, c_{CRC}=0.5 and c_{CRR}=1.

In a more elaborate approach, the weighting conditions take the penalty adjusted energy of the two processing paths 42 into account. If the attenuation A_{LC} of the LC processing path is expressed as the ratio between output energy E_{LC,output} and the input energy E_{LC}, A_{LC}=E_{LC,output}/E_{LC}, then the penalty adjusted energy for the LC and CR processing paths can be written as:

$${E}_{LC}^{′} = {E}_{LC} {A}_{LC}^{p} \qquad ( eq . 2 )$$

$${E}_{CR}^{′} = {E}_{CR} {A}_{CR}^{p} ,$$

where p is a penalty exponent. Finally, a ratio between the two penalty adjusted energies is calculated as E_{LC}′/E_{CR}′. This ratio can be seen as a measure of the relative relevance of the two channels. For practical reasons, the ratio may be converted to dB:

$$R = 20 log \frac{{E}_{LC}^{′}}{{E}_{CR}^{′}} , \qquad ( eq . 3 )$$

For values of R within a given range around zero, i.e. the penalty adjusted energies are relatively similar for both processing paths, the combination module 48 may apply a balanced setting where weighting coefficients mentioned above are used, i.e. c_{LCL}=1, c_{LCC}=0.5, c_{CRC}=0.5 and c_{CRR}=1. The range may be determined empirically, and as an example it could be |R|<6 dB.

Extreme values of R, deviating significantly from zero, indicate that one of the pairs is much weaker than the other. In such cases, it may be advantageous to completely ignore the weaker pair. In other words, when R exceeds a first threshold, i.e. the LC processing path is dominating, the combination module 48 may apply a first extreme setting where c_{LCL}=1, c_{LCC}=1, c_{CRC}=0 and c_{CRR}=0, and when R is smaller than a second threshold, i.e. the CR processing path is dominating, the combination module 48 may apply a second extreme setting where c_{LCL}=0, c_{LCC}=0, c_{CRC}=1 and c_{CRR}=1. The first and second thresholds may be determined empirically, and as an example they could be ±24 dB.

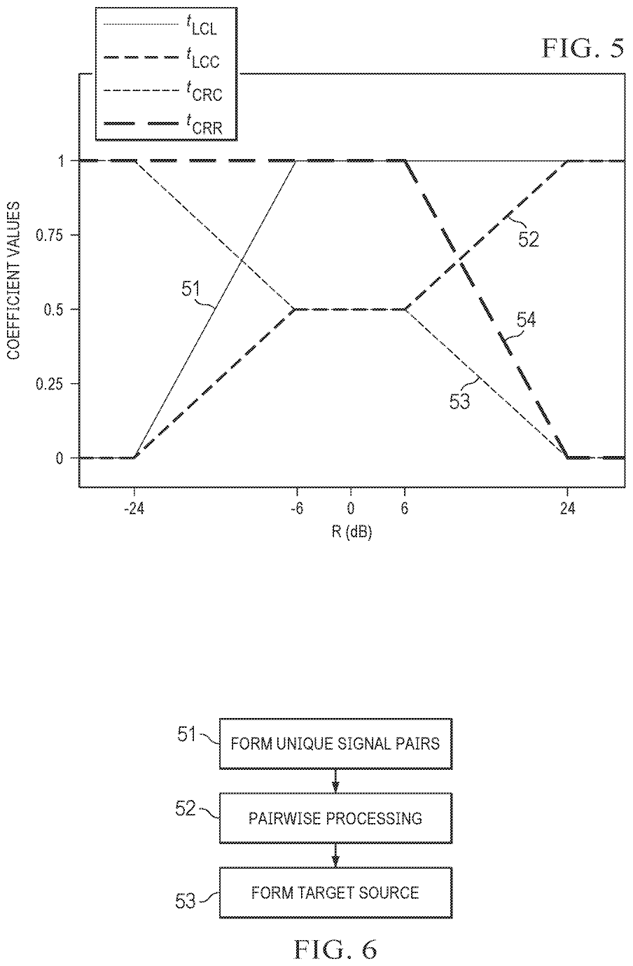

The combination module 48 may further be configured to interpolate the coefficients between the balanced setting and the first and second extreme settings, respectively, thereby providing a complete mapping from R to the weighting coefficients. FIG. 5 shows an example of such a mapping, with linear interpolation, wherein lines 51, 52, 53, 54 indicate the coefficients c_{LCL}, c_{LCC}, c_{CRC} and c_{CRR} as functions of the ratio R. It should be noted that the interpolation may instead be non-linear, for example a smoothed step-function, like a sigmoid function.

In practice, the ratio between the penalty adjusted energies tend to vary very rapidly in time, and using the approach above may lead to spatial instability. In order to improve stability, the penalty adjusted energies can be smoothed, e.g. using a Hamming window e.g. over 31 frames (corresponding to 660 ms for frames with 1024 sample stride at 48 kHz).

The process performed in the systems in FIGS. 1 and 4 can be outlined as shown in FIG. 6. First, in step S1, N audio signals of a multi-channel audio input are combined into a set of unique signal pairs. Then, in step S2, each unique signal pair is subject to pairwise processing, to obtain process signal pairs including source separated versions of the audio signals in each pair. Finally, in step S3, the processed signal pairs are combined to form a target source (e.g. dialog) having N target audio signals corresponding to the N audio signals.

Unless specifically stated otherwise, as apparent from the following discussions, it is appreciated that throughout the disclosure discussions utilizing terms such as “processing”, “computing”, “calculating”, “determining”, “analyzing” or the like, refer to the action and/or processes of a computer hardware or computing system, or similar electronic computing devices, that manipulate and/or transform data represented as physical, such as electronic, quantities into other data similarly represented as physical quantities.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention. Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Note that when the method includes several elements, e.g., several steps, no ordering of such elements is implied, unless specifically stated. Furthermore, an element described herein of an apparatus embodiment is an example of a means for carrying out the function performed by the element for the purpose of carrying out the invention. In the description provided herein, numerous specific details are set forth. However, it is understood that embodiments of the invention may be practiced without these specific details. In other instances, well-known methods, structures and techniques have not been shown in detail in order not to obscure an understanding of this description.

The person skilled in the art realizes that the present invention by no means is limited to the specific embodiments described above. On the contrary, many modifications and variations are possible within the scope of the appended claims. For example, the invention may be applied to other audio input formats than those discussed above. Also, the pairwise processing may differ from that discussed above.

1. A method for separating a target audio source from a multi-channel audio input including N audio signals, N>=3, the method comprising:
combining the N audio signals into at least two unique signal pairs, each signal pair including two of the N audio signals;
performing pairwise source separation on the at least two signal pairs to generate at least two processed signal pairs, each processed signal pair including source separated versions of the audio signals in the signal pair; and
combining the at least two processed signal pairs to form the target audio source having N target audio signals corresponding to the N audio signals.

2. The method according to claim 1, wherein the at least three audio signals include surround audio channels, multi-track signals, higher order ambisonic signals, object audio signals and/or immersive audio signals.

3. The method according to claim 1 or 2, wherein:
for each audio signal occurring in only one signal pair of the at least two unique signal pairs, the corresponding target audio signal is equal to the source separated version of the audio signal occurring in only one signal pair,
for each audio signal occurring in more than one signal pair, the corresponding target audio signal is equal to a weighted combination of all source separated versions of this audio signal.

4. The method according to claim 3, wherein the weighting of the weighted combination is dynamic in time and/or frequency.

5. The method according to claim 3, wherein the weighting of the weighted combination is non-linear.

6. The method according to claim 1, further comprising mixing the N target audio signals with the N audio signals to form N output audio signals.

7. The method according to claim 1, wherein the multi-channel input includes M>N audio signals, and further comprising mixing the N target audio signals with the M audio signals to form M output audio signals.

8. The method according to claim 6, wherein the mixing is done with a mixing ratio that is dynamic in time and/or frequency.

9. The method according to claim 1, wherein the pairwise source separation includes, for each unique signal pair:
processing the audio signals in the signal pair with a spatial cue based separation module to obtain an intermediate audio signal pair, and
processing the intermediate audio signal pair with a source cue based separation module to generate the processed signal pair, the source cue based separation module implementing a neural network trained to predict a noise reduced output audio signal given samples of the intermediate audio signal pair.

10. The method according to claim 9, further comprising:
determining, using a neural network classifier and based on the multi-channel audio input, a probability metric indicting a likelihood that the multi-channel audio input comprises the target audio source; and
controlling a gain of the processed signal pair based on said probability metric.

11. The method according to claim 9,
wherein said at least two unique signal pairs include a first signal pair including a first unique audio signal, L, and a shared audio signal, C, and a second signal pair including a second unique audio signal, R, and said shared audio signal, C, and
wherein the target audio signals, \hat{d}_{L}, \hat{d}_{C}, \hat{d}_{R}, corresponding to the first unique audio signal, L, the shared audio signal, C, and the second unique audio signal, R, are defined as:
$$\hat{d} = [ \begin{matrix}{\hat{d}}_{L} \\ {\hat{d}}_{C} \\ {\hat{d}}_{R}\end{matrix} ] = [ \begin{matrix}{c}_{LCL} & 0 & 0 & 0 \\ 0 & {c}_{LCC} & {c}_{CRC} & 0 \\ 0 & 0 & 0 & {c}_{CRR}\end{matrix} ] [ \begin{matrix}{L}_{proc} \\ C {1}_{proc} \\ C {2}_{proc} \\ {R}_{proc}\end{matrix} ] ,$$
where L_{proc} and C1_{proc} are the source separated versions of the audio signals of the first signal pair, C2_{proc} and R_{proc} are the source separated versions of the audio signals of the second signal pair, and c_{LCL}, c_{LCC}, c_{CRC} and c_{CRR} are weighting coefficients.

12. The method according to claim 11, wherein the weighting coefficients are set to c_{LCL}=1, c_{LCC}=0.5, c_{CRC}=0.5 and c_{CRR}=1.

13. The method according to claim 11, wherein the at least two processed signal pairs include first and second processed signal pairs corresponding to said first and second signal pairs, further comprising:
computing a penalty adjusted energy for the first and second processed signal pairs, wherein the penalty adjusted energy of a signal pair is defined as EₒᵤₜA^{p}, where Eₒᵤₜ is the output energy, A is the attenuation caused by the processing, and p is a penalty exponent;
computing a ratio between said penalty adjusted energies of the first and second processed signal pairs; and
when said ratio is within a given range, applying a balanced setting where c_{LCL}=1, c_{LCC}=0.5, c_{CRC}=0.5 and c_{CRR}=1.

14. The method according to claim 13, further comprising, when said ratio is greater than a first threshold, applying a first extreme setting where c_{LCL}=1, c_{LCC}=1, c_{CRC}=0 and c_{CRR}=0, and when said ratio is smaller than a second threshold applying a second extreme setting where c_{LCL}=0, c_{LCC}=0, c_{CRC}=1 and c_{CRR}=1.

15. The method according to claim 14, further comprising interpolating said coefficients between the balanced setting and the first and second extreme settings, respectively.

16. The method according to claim 11,
wherein the multi-channel input audio signal comprises a left channel, L, a right channel, R, and a center channel, C,
wherein the first signal pair consists of the left channel L and the center channel C, and the second signal pair consists of the right channel R and the center channel C, and
wherein the target source is dialog.

17. A system for separating a target audio source from a multi-channel audio input including N audio signals, N>=3, the system comprising:
a pair forming module (1) configured to combine the N audio signals into at least two unique signal pairs, each signal pair including two of the N audio signals;
a processing module (2) configured to perform pairwise source separation on the at least two signal pairs to generate at least two processed signal pairs, each processed signal pair including source separated versions of the audio signals in the signal pair; and
a combination module (3) configured to combine the at least two processed signal pairs to form the target audio source having N target audio signals corresponding to the N audio signals.

18. The system according to claim 17, wherein the at least three audio signals include surround audio channels, multi-track signals, higher order ambisonic signals, object audio signals and/or immersive audio signals.

19. The system according to claim 17, wherein:
for each audio signal occurring in only one signal pair of the at least two unique signal pairs, the corresponding target audio signal is equal to the source separated version of the audio signal occurring in only one signal pair,
for each audio signal occurring in more than one signal pair of the at least two unique signal pairs, the corresponding target audio signal is equal to a weighted combination of all source separated versions of the audio signal occurring in more than one signal pair.

20. The system according to claim 17, further comprising a mixing module (4) configured to mix the N target audio signals with the N audio signals to form N output audio signals.

21-27. (canceled)
